(19) United States
(12) Patent Application Publication
(10) Pub. No.: US 2026/0175244 A1
(43) Pub. Date: Jun. 25, 2026

(54) WAND CARRIAGES AND KIT FOR PRESSURE WASHER SYSTEMS AND PRESSURE WASHER SYSTEMS EQUIPPED THEREWITH

(71) Applicant: Randy Paul Banic, LaPorte, IN (US)

(72) Inventors: Randy Paul Banic, LaPorte, IN (US); Terry Gaddy, LaPorte, IN (US)

(21) Appl. No.: 19/429,167

(22) Filed: Dec. 22, 2025

Related U.S. Application Data
(60) Provisional application No. 63/737,121, filed on Dec. 20, 2024.

(51) Int. Cl. B05B 9/00; B08B 3/02

(52) U.S. Cl. CPC B05B 9/007; B08B 3/026

(57) ABSTRACT

Wand carriages and kits for pressure washer systems, and pressure washer systems provided therewith. Such a wand carriage includes a wand nest that receives the wand tube of a pressure washer. The wand nest adjustably mounts to a frame of the wand carriage such that the pitch orientation of the wand nest, and thus the wand tube, relative to the frame of the wand carriage. The wand nest can be adjusted to any desired angular pitch orientation and then fixed in the selected position by tightening a clamp screw. A kit may include two different wand carriages to which the wand nest can be alternatively secured. In this way, the wand nest can be used to attach the wand to and switch between either one of the wand carriages depending on a given usage need.

### CROSS-REFERENCE TO RELATED APPLICATIONS

This application claims the benefit of provisional U.S. Patent Application No. 63/737,121 filed Dec. 20, 2024, the contents of which are incorporated herein by reference.

### BACKGROUND OF THE INVENTION

The invention generally relates to pressure washer systems, and more particularly to wand carriages for securing a wand of a pressure washer system and to wand carriage kits for use with pressure washer systems.

Pressure washers, also commonly referred to as power washers, are devices designed to deliver a high-pressure stream of water to clean various surfaces. Pressure washers are widely used in both residential and industrial settings for tasks such as cleaning vehicles, driveways, decks, building exteriors, and other hard surfaces. Pressure washers generally include a water inlet for connection to a water source (e.g., a tank or hose), a pump powered by an electric motor or gasoline engine to pressurize water received from the source, a high-pressure hose connected to an outlet of the pump, and a spray wand or lance connected to the hose and through which the pressurized water is expelled as a high-velocity stream. The water stream allows for the effective removal of dirt, grime, mold, and other debris from surfaces, often without the need for chemical cleaners. However, the high velocity of the water stream also gives rise to jet propulsion forces on the wand in the direction opposite the stream, which can cause handling and control of the wand difficult.

To make the wand easier to manipulate, wand support systems have been developed that that are intended to compensate for propulsion forces, especially when used for cleaning flat surfaces like sidewalks and floors. US2015/0014450A1 discloses a mobile pressure washer wand holder intended to assist users in handling the spray wand during operation. While not intending to promote any particular interpretation, the wand holder is described in US2015/0014450A1 as including a hollow base that can be filled with a liquid to increase stability during use. The base is equipped with wheels to facilitate movement, and a wand-holding clamp is attached to the top of the base for the purpose of allowing the wand to be held at a fixed angle relative to the base. This arrangement is intended to reduce the physical effort required by an operator to control the wand and enhance the consistency of the cleaning process by maintaining the outlet nozzle of the wand at a relatively constant height above the surface being cleaned. However, the base can also be bulky and inconvenient when pressure washing surfaces other than flat surfaces.

It would be desirable if a wand support system were available that was capable of being more versatile and more easily usable in various different circumstances.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, wand carriages and kits for use with pressure washer systems, and pressure washer systems equipped therewith.

According to one nonlimiting aspect, a wand carriage for supporting a wand of a pressure washer system includes a frame, at least one wheel rotatably coupled to the frame and configured to engage a support surface to support the frame in a spaced relation from the frame, and a wand nest mounted to the frame. The wand nest includes an adjustment mechanism for adjusting an angular orientation of the wand nest relative to the frame.

According to another nonlimiting aspect, a kit for use with a pressure washer system having a wand with a nozzle includes a first wheeled wand carriage, a second wheeled wand carriage, and a wand nest for clamping to the wand. Each wheeled wand carriage has a mounting bracket. The wand nest can be alternatively mounted to the mounting bracket of each of the first wheeled wand carriage and the second wheeled wand carriage. A pitch orientation of the wand carriage can be adjusted relative to each of the first wheeled carriage and the second wheeled carriage when mounted thereto, respectively.

According to other nonlimiting aspects, a pressure washer system is provided equipped with a wand carriage or kit as described above.

Technical aspects of wand carriage as described above preferably include the ability to provide a more versatile wheeled wand carriage for supporting the wand of a pressure washer system.

These and other aspects, arrangements, features, and/or technical effects will become apparent upon detailed inspection of the figures and the following description.

### BRIEF DESCRIPTION OF THE DRAWINGS

FIG. 1 is a perspective view of a pressure washer system and a wand carriage supporting a wand of the pressure washer system according to a nonlimiting embodiment of the invention.

FIG. 2 is a perspective view of the wand carriage of FIG. 1.

FIG. 3 is a top plan view of the wand carriage of FIG. 1.

FIG. 4 is a front elevation view of the wand carriage of FIG. 1.

FIG. 5 is a right side elevation view of the wand carriage of FIG. 1.

FIG. 6 is a left side elevation view of the wand carriage of FIG. 1.

FIG. 7 is a perspective view of a wand carriage according to another nonlimiting embodiment of the invention, wherein the wand carriage includes a removable wand nest.

FIG. 8 is an enlarged top view of the wand carriage of FIG. 7 in partial cross-section to visualize mounting of the wand nest to the wand carriage.

FIG. 9 is a perspective exploded view of the wand nest of FIG. 7.

FIG. 10 is a front exploded view of the wand nest of FIG. 7.

FIG. 11 is a front assembled view of the wand nest mounted to the wand carriage of FIG. 7.

FIG. 12 is a cross-sectional view of the wand nest mounted to the wand carriage of FIG. 7.

FIG. 13 is a perspective view of a wand carriage according to yet another nonlimiting embodiment of the invention, wherein the wand carriage includes the removable wand nest of FIG. 7.

FIG. 14 is a side elevation view of the wand carriage of FIG. 13.

FIG. 15 is a front elevation view of the wand carriage of FIG. 13.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of the embodiment(s) to which the drawings relate. The following detailed description also identifies certain but not all alternatives of the embodiment(s). As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

To facilitate the description provided below of the embodiment(s) represented in the drawings, relative terms, including but not limited to, “proximal,” “distal,” “anterior,” “posterior,” “vertical,” “horizontal,” “lateral,” “front,” “rear,” “side,” “forward,” “rearward,” “top,” “bottom,” “upper,” “lower,” “above,” “below,” “right,” “left,” etc., may be used in reference to the orientation of the wand carriage during its use and/or as represented in the drawings. All such relative terms are useful to describe the illustrated embodiment(s) but should not be otherwise interpreted as limiting the scope of the invention.

As used herein the terms “a” and “an” to introduce a feature are used as open-ended, inclusive terms to refer to at least one, or one or more of the features, and are not limited to only one such feature unless otherwise expressly indicated. Similarly, use of the term “the” in reference to a feature previously introduced using the term “a” or “an” does not thereafter limit the feature to only a single instance of such feature unless otherwise expressly indicated.

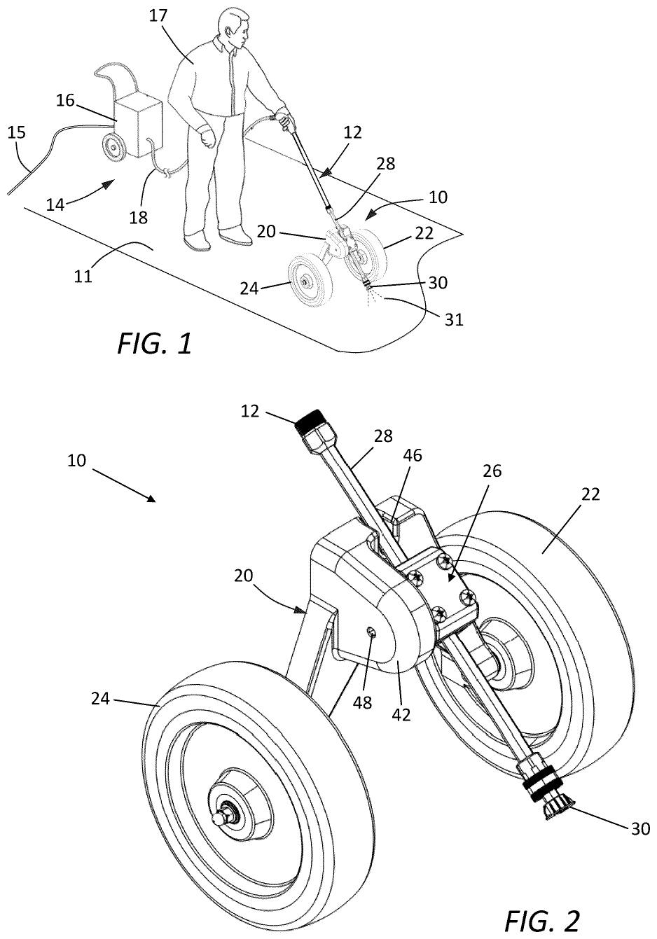

Turning now to the nonlimiting embodiments represented in the drawings, FIG. 1 depicts a wand carriage 10 coupled to a wand 12 of a pressure washer system 14. The pressure washer system 14 includes a pressure washer 16 that includes a pump system (not shown) for pressurizing a liquid, typically water, received from a source 15, represented in FIG. 1 as a hose. The pressure washer 16 delivers the liquid through a conduit 18, such as a hose, to the wand 12. The nonlimiting embodiment of the wand 12 shown in FIG. 1 is represented as including an elongate tube 28 with a proximal end coupled to the conduit 18 and a nozzle 30 mounted to a distal end of the tube 28 for directing a high-pressure and/or high-velocity stream 31 of the liquid out through the distal end of the wand 12 toward a surface 11 (e.g., floor, deck, sidewalk, wall, road, etc.) that supports the wand carriage 10. The nozzle 30 can be adapted to produce streams of various different spray patterns and/or may be interchangeable with different nozzles 30 capable of producing streams 31 having different spray patterns. As shown in FIG. 1, the wand 12 is coupled to the wand carriage 10 in a manner that supports the wand 12 while enabling the wand 12 to be traversed across the surface 11 by an operator 17. The wand tube 28 is typically a rigid tube through which the pressurized liquid flows. The wand tube 28 may optionally be a portion of an extension piece that is separate from the wand 12 and includes a proximal end coupler for coupling to the distal end of either the conduit 18 or the wand 12. However, the wand tube 28 may be an integral of the wand 12 without any separate nozzle. In either case, the nozzle 30 is disposed at the opposite, distal end of the wand tube 28 for propelling the stream 31 of liquid toward the surface 11.

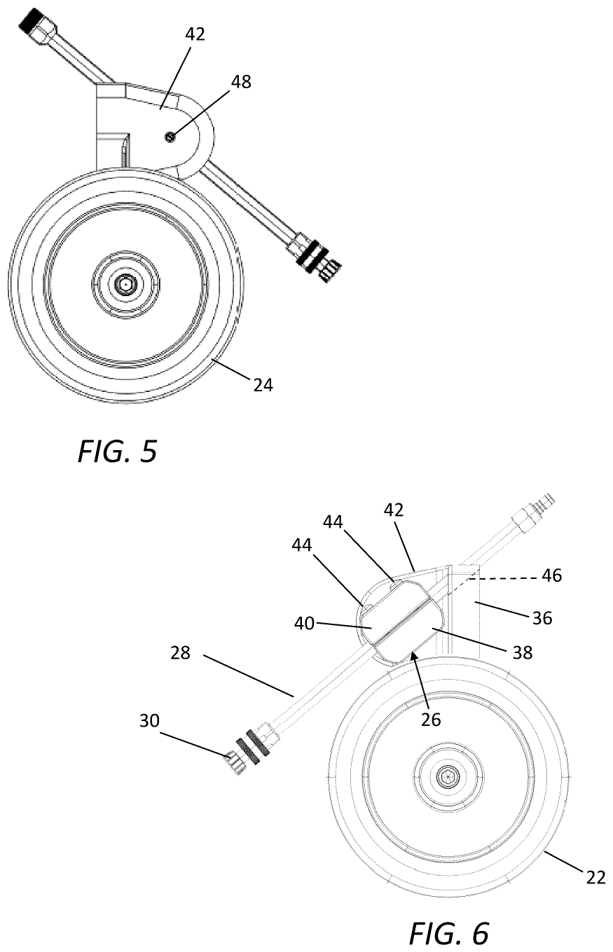

As best seen in FIGS. 2-6, the wand carriage 10 includes a carriage frame 20, a wand nest 26 carried by the carriage frame 20, and a pair of left and right wheels 22 and 24 rotatably mounted at opposite respective left and right sides of the frame 20. The wand nest 26 defines a wand clamping mechanism (“wand clamp”) that is configured to receive and releasably retain the wand tube 28 of the pressure washer system 14 of FIG. 1, though it should be understood that the wand nest 26 can be adapted to receive and retain wand tubes of different configurations. The wand tube 28 is shown as coupled at an angle relative to the carriage frame 20 and therefore at an angle to a surface (e.g., 11 in FIG. 1) to be power washed.

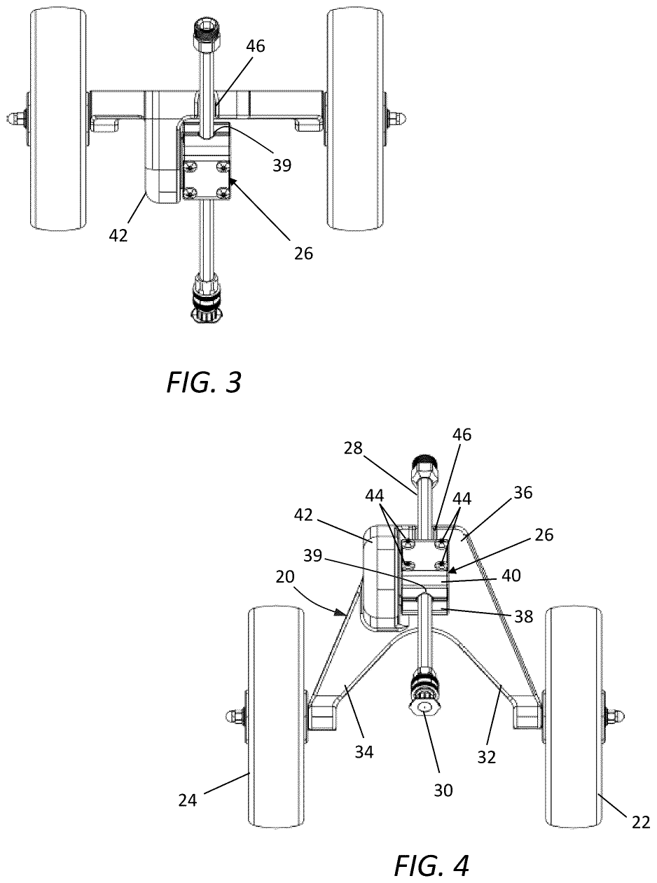

As best seen in FIGS. 3 and 4, the carriage frame 20 has a generally planar, inverted V-shape that defines a left leg 32 and a right leg 34 extending outwardly and downwardly from a central upper apex portion 36 of the frame 20. The legs 32 and 34 and the apex portion 36 are generally planar, as best seen in FIG. 3. The left and right wheels 22 and 24 are rotatably coupled to the laterally outer sides of the respective left and right legs 32 and 34, for example, with pins or other types of axles. In this example, each wheel 22 and 24 is rotatably coupled to the respective leg 32 and 34 with separate axles defined by individual pins. In other embodiments, a single axle could extend across and through the ends of both legs 32 and 34 with the wheels 22 and 24 rotatably mounted to opposite ends thereof.

The wand nest 26 is disposed on a front side of the apex portion 36 and configured to carry the tube 28 at an acute angle pointed downwardly from the apex portion 36 toward a point forward of the front side of the carriage frame 20. In this example, the wand nest 26 orients the tube 28 downwardly at an approximately 45° angle relative to vertical when the plane of the carriage frame 20 is vertical. In other words, the wand nest 26 orients the tube 28 at approximately a 45° angle relative to the plane of the carriage frame 20. However, in other embodiments the wand nest 26 may be configured to orient the tube 28 downwardly at other acute angles between 0° and 90° relative to the plane of the carriage frame 20. Since the carriage frame 20 itself may be pivoted about the axis of the wheels 22 and 24, the actual angle of the tube 28 relative to a supporting surface will depend on the angle of the frame 20 relative to the surface. Thus, an operator can easily manipulate the angle of attack of the stream emitted from the nozzle 30 by simply rotating the orientation of the carriage frame 20 about the axis of the wheels 22 and 24.

As best seen in FIGS. 3, 4, and 6, the wand nest 26 includes a bottom clamp pad 38 and a top clamp pad 40 that defines the wand clamp. The top and bottom clamp pads 40 and 38, when clamped together, define a receiving cavity 39 that receives the wand tube 28 therein and securely clamps the wand tube 28 in a fixed position relative to the carriage frame 20. The receiving cavity 39 may have various cross-sectional shapes, such as an oval shape, circular shape, or polygonal shape. In this embodiment, the receiving cavity 39 has a diamond shaped cross-section defined by opposing aligned elongate V-shaped grooves on the opposite facing clamping surfaces of the bottom and top clamp pads 38 and 40. The bottom clamp pad 38 is adjustably mounted to the frame 20 by a bracket portion 42 that extends forward from the apex portion 36. The bracket 42 may be an integral portion of the frame 20, for example by being molded as a unitary piece with the frame 20, or the bracket 42 may be fixedly secured to the frame 20, for example with fasteners. The bracket 42 is generally planar and extends approximately perpendicular to the plane of the V-shape of the carriage frame 20. The bracket 42 is offset from a centerline of the frame 20 and the bottom clamp pad 38 extends from the bracket across the centerline of the frame 20 so that the wand tube 28 is aligned approximately with the centerline of the frame 20 when operatively clamped between the bottom and top clamp pads 38 and 40. In this example, the bottom clamp pad 38 extends approximately perpendicularly outwardly from the side of the bracket 42 oriented such that a top surface of the bottom clamp pad 38 is oriented along the angular orientation (in this case, 45°) of the wand tube 28. The top clamp pad 40 fits onto the top surface of the bottom clamp pad 38 and is clamped thereto by any suitable clamping mechanism. In this embodiment, the top clamp pad 40 is clamped to the bottom clamp pad 38 with threaded fasteners 44, such as screws or bolts, which extend through the top clamp pad 40 and thread into the bottom clamp pad 38. However, other types of clamping mechanisms could be used, such as cam clamps, hose clamps, and/or C-clamps, to give just a few non-limiting examples. In this embodiment, the bracket 42 is in the form of a short, generally planar wall section extending perpendicularly forward from the right side of the front side of the apex portion 36; however, other types and/or forms of hanger brackets could be used that are configured to secure the lower clamp pad 38 in the desired position in front of the carriage frame 20.

A recessed trough 46 is defined in the top surface of the apex portion 36 and angled downwardly for receiving the wand tube 28 at the desired acute angle relative to the carriage frame 20. As best seen in FIGS. 2 and 6, the trough 46 is preferably just deep enough so that the wand tube 28 will rest in the trough project up through the top surface of the apex portion 36 with the top of the tube 28 recessed slightly below the forward top edge of the apex portion 36. Preferably, the plane of the trough 46 is aligned perpendicular to the plane of the frame 20 along the centerline of the frame 20 so that the plane of the wand tube 28 is centered between the two wheels 22 and 24.

A screw 48 secures the wand nest 26 to the mounting bracket 42 in such a way that the angular pitch orientation of the wand nest 26, and thus the wand tube 28 when clamped therein, can be adjusted relative to the frame 20. The screw 48 extends through the bracket 42 and screws into a portion of the wand nest 26, such as either on of the bottom clamp pad 38 or the top clamp pad 40. If it is desired to adjust the pitch of the wand next 26, the screw 48 can be loosened, and the wand nest 26 can be pivoted about the screw to a new desired pitch. Thereafter, the screw 48 can be re-tightened to again fix the pitch orientation of the wand nest 26 relative to the frame 20. In some embodiments, the entire wand nest 26 can be removed from the wand carriage 10 as a single unit by simply completely removing the screw 48. This may be useful, for example, for using the wand nest 26 with a different support carriage as discussed in more detail hereinafter.

In use, the wand tube 28 is clamped into the wand nest 26 and operatively coupled to the conduit 18 or wand 12. Then, with the pressure washer (e.g., 16 in FIG. 1) turned on, an operator can easily move the nozzle 30 along a support surface (e.g., 11 in FIG. 1) at a relatively constant distance and attack angle by simply rolling the wand carriage 10 along the surface on the wheels 22 and 24. If it is desired to adjust the distance of the nozzle 30 from the surface, then the wand nest 26 can be loosened sufficiently, for example by unthreading the threaded fasteners 44, to allow the wand tube 28 to slide forward and/or rearward along the trough 46 and the receiving cavity 39 between the clamp pads 38 and 40. When the nozzle 30 is in the desired position, the wand nest 26 can be re-tightened, for example by re-tightening the threaded fasteners 44, until the wand tube 28 is again fixedly secured in the wand nest 26. During use, the attack angle of the liquid stream (e.g., 31 in FIG. 1) emanating from the nozzle 30 may be easily adjusted by simply pivoting the carriage frame 20 forward and/or rearward about the axles of the wheels 22 and 24. In this way, an operator can easily control and adjust the orientation of the nozzle 30 and stream emitted therefrom. In addition, the wand carriage 10 may make it easier to use the pressure washer for longer periods of time by supporting at least a portion of the weight of the wand 12 and/or the wand tube 28.

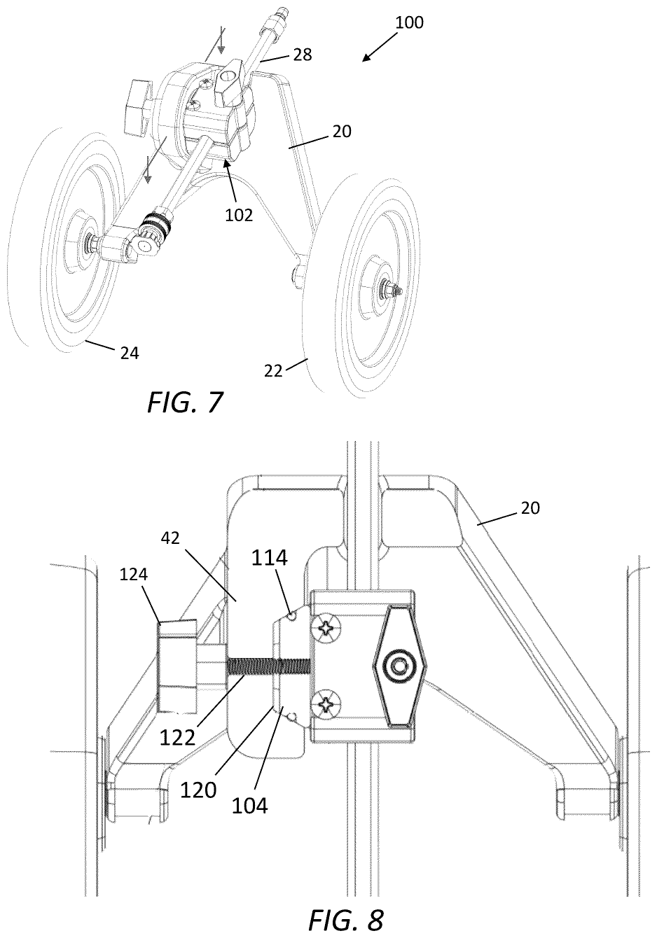

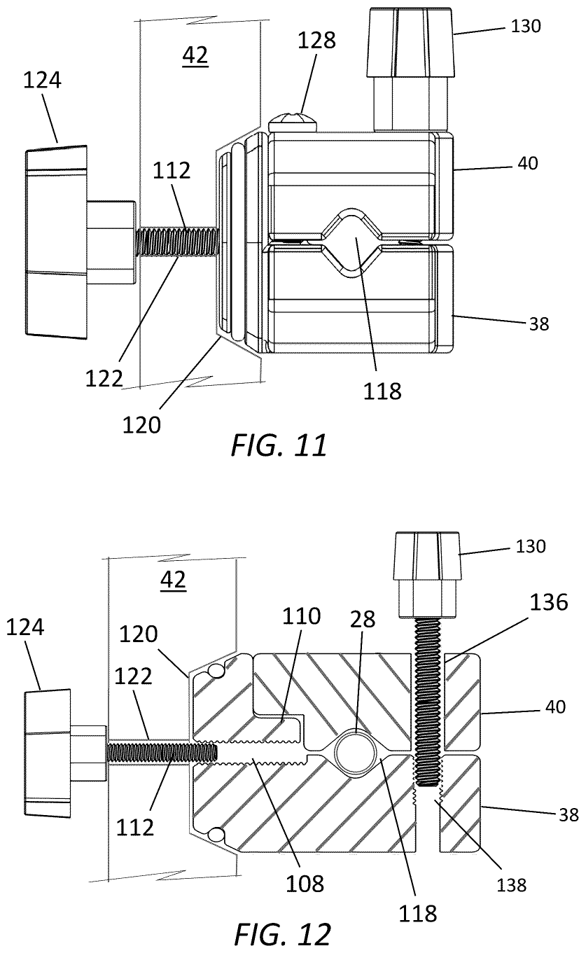

Turning to FIGS. 7-15, other embodiments wand carriages 100 and 200 are shown, which include a different wand nest 102 that can be easily mounted and dismounted from the carriage frame 20. In view of similarities between the embodiments of FIGS. 1-6, 7-12, and 13-15, the following discussion of FIGS. 7-15 will focus primarily on aspects of the embodiments of FIGS. 7-15 that differ from the embodiment of FIGS. 1-6 in some notable or significant manner. Other aspects of the embodiments of FIGS. 7-15 not discussed in any detail can be, in terms of structure, function, materials, etc., essentially as was described for the embodiment of FIGS. 1-6.

In FIGS. 7-12, the wand nest 102 includes not only the wand clamp defined by top and bottom clamp pads 40 and 38 for clamping the wand tube 28, but also includes a tapered clutch 104 that allows for rotation of the wand nest 102 relative to the bracket 42 of the frame 20. Whereas in the wand carriage 10 the bottom clamp pad 38 was fixedly attached to the bracket 42, in this embodiment, the bottom clamp pad 38 includes the tapered clutch 104 that mounts to the bracket 42 in such a way that the bottom clamp pad 38 can be selectively rotated to a desired angular orientation relative to the frame 20 and then tightened to prevent further rotation until later again loosened. In addition, unlike the wand nest 26 of FIGS. 1-6, the wand nest 102 can be dismounted as a single unit from the frame 20, either with or without removing the wand 12 from the wand clamp, and transferred to another carriage as described further below.

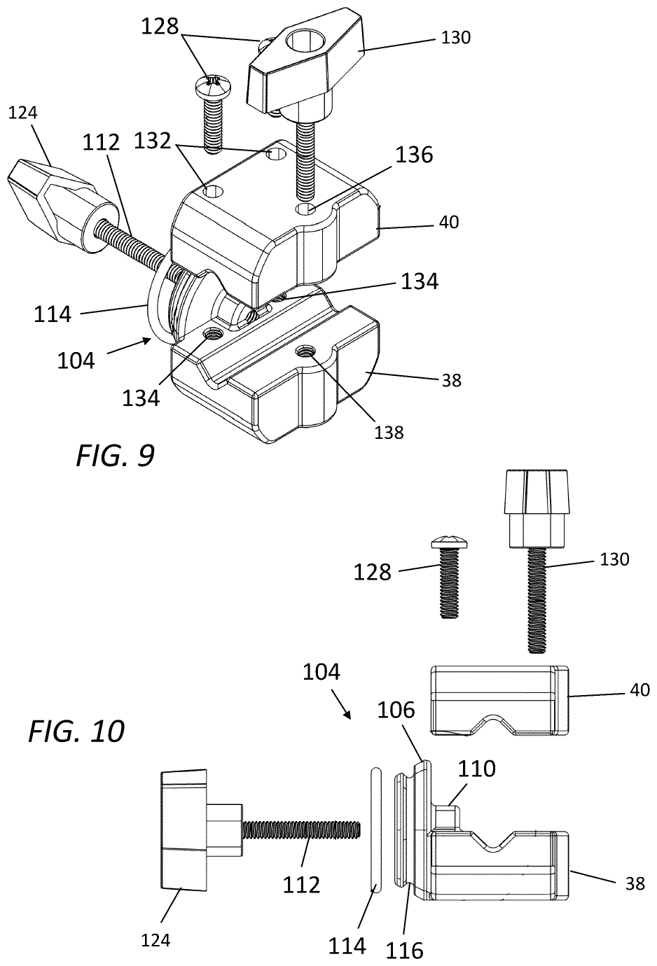

As best seen in FIGS. 9-12, the tapered clutch 104 is fixedly attached to the bottom clamp pad 38 and projects laterally outwardly from one side of the bottom clamp pad 38. A tapered boss 106 defined by a frustum is disposed on the side of the bottom clamp pad 38. The frustum has a larger diameter near the side wall of the bottom clamp pad 38 and tapers to a smaller diameter further away from the side wall. A threaded bore 108 (FIG. 12) extends into the tapered boss 106 from the narrow end of the frustum along the axis of the frustum. A cylindrical boss 110 axially aligned with the threaded bore 108 extends from the larger diameter end of the frustum into the body of the bottom clamp pad 38. The threaded bore 108 also extends into the cylindrical boss 110 to provide additional thread engagement for a threaded torquing bolt 112. The cylindrical boss 110 extends part way across the top of the bottom clamp pad 38, but does not intersect with the receiving cavity 118 for the wand tube 28 so that the torquing bolt 112 does not interfere with the wand tube when clamped in the receiving cavity 118.

As best seen in FIGS. 8, 11, and 12, the bracket 42 includes a clutch mount defined by a frustum-shaped tapered recess 120 in its medial sidewall that is shaped complementary to the frustum shape of the tapered boss 106. The tapered recess 120 has a tapered circumferential side wall that has narrows in diameter as it extends into the thickness of the bracket 42. The axis of the tapered recess 120 is preferably parallel with the axis or axes of the wheels 22 and 24. The tapered boss 106 nests into the tapered recess 120 such that the wand nest 102 can rotate in the tapered recess 120 in a plane that is generally orthogonal to the axis or axes of the wheels 22 and 24. The torquing bolt 112 extends through a bore 122 extending through the bracket 42 from its lateral side to its medial aligned with the axis of the tapered recess 120. The bore 122 is preferably a smooth bore that does not threadedly engage the threaded torquing bolt 112.

To mount the wand nest 102 to the bracket 42, the tapered boss 104 is inserted into the tapered recess 120 of the clutch mount, and the torquing bolt 122 inserted through the bore 122 and threaded into the threaded bore 108. As the torquing bolt 122 is threaded into the threaded bore 108, the shoulder of a torque nut 124 at the end of the torquing bolt 112 engages the lateral side of the bracket 42 and pulls the tapered sidewall of the tapered boss 106 against the tapered sidewall of the tapered recess 120. When the torquing bolt 112 is thus tightened a sufficient amount, friction between the tapered boss 106 and the tapered recess 120 clamps the wand nest 102 in a selected angular orientation relative to the bracket 42 (and frame 20). If it is desired to adjust the angular orientation of the wand 12, the torquing bolt 112 can be loosened enough to release the frictional clamping without fully removing the wand nest 102 from the bracket 42 and the wand nest 102 can be rotated about the axis of the tapered recess 120 to another selected position. Thereafter, the torquing bolt 112 can be re-tightened to again fix the wand next 102 in the new selected rotational orientation.

A resilient friction member 114 may be provided between the tapered sidewall of the tapered boss 106 and the tapered sidewall of the tapered recess 120 to enhance the friction coupling between the wand nest 102 and the bracket 42. In this embodiment, the resilient friction member 114 is in the form of a resilient O-ring seated in a circumferential seating groove 116 that extends around the outer surface of the frustum of the tapered boss 106. The seating groove 116 is preferably in a plane that is perpendicular to the axis of the frustum and threaded bore 108. The friction member 114 may be made of a resilient flexible material, such as rubber or elastomer, to provide an enhanced frictional engagement between the tapered boss 106 and bracket 42 as explained hereinafter. However, in other embodiments, the resilient friction member 114 may have a form other than that of an O-ring, such as rubber or elastomeric pads, strips, bands, ridges, nobs, or other shapes. In some embodiments, the resilient friction member 114 may be carried by the tapered side wall of the tapered recess 120. The resilient friction member 114 can reduce the amount of torque required by the torque nut 124 to securely fix the rotational position of the wand 12 relative to the frame 20. The resilient friction member 114 can also provide for improved control of the rotation of the wand nest 102 (and the wand 12) relative to the frame 20 when the torque nut 124 is loosened for repositioning than the tapered clutch 104 without the friction member 114. However, the tapered clutch 104 would still function without the resilient friction member 114.

An adjustable wand clamping mechanism is provided for mounting the top clamp pad 40 to the bottom clamp pad 38 and clamping the wand tube 28 in the receiving cavity 118. The wand clamping mechanism includes at least one, and preferably two screws 128 (e.g., pan head screws) and a wing nut screw 130 secure the top clamp pad 40 to the bottom clamp pad 38. Each screw 128 extends through a smooth through bore 132 through the top clamp pad 40 and screws into a corresponding threaded bore 134 in the bottom clamp pad 38. The wing nut screw 130 extends through a smooth bore 136 through the top clamp pad 40 and into a corresponding threaded bore 138 in the bottom clamp pad 38. The screws 128 can be tightened to semi-tension (partially clamp) the top clamp pad 40 onto the wand tube 28 disposed in the receiving cavity 118. In the semi-tensioned state, the wand tube 28 can slide axially forward and backward within the receiving cavity 118 while still being retained within the receiving cavity 118. This allows the position of the wand 12 relative to the wand nest 102 to be adjusted so as to project closer toward a surface or be retracted further away from a surface yet remain in a semi fixed position, thereby allowing an operator to test the setup prior to fully clamping the wand tube 28. Once the wand tube 28 is adjusted to the desired position, the winged clamp nut 130 may then be tightened to securely clamp the wand tube 28 in a fixed position in the wand nest 102 with minimal torque applied.

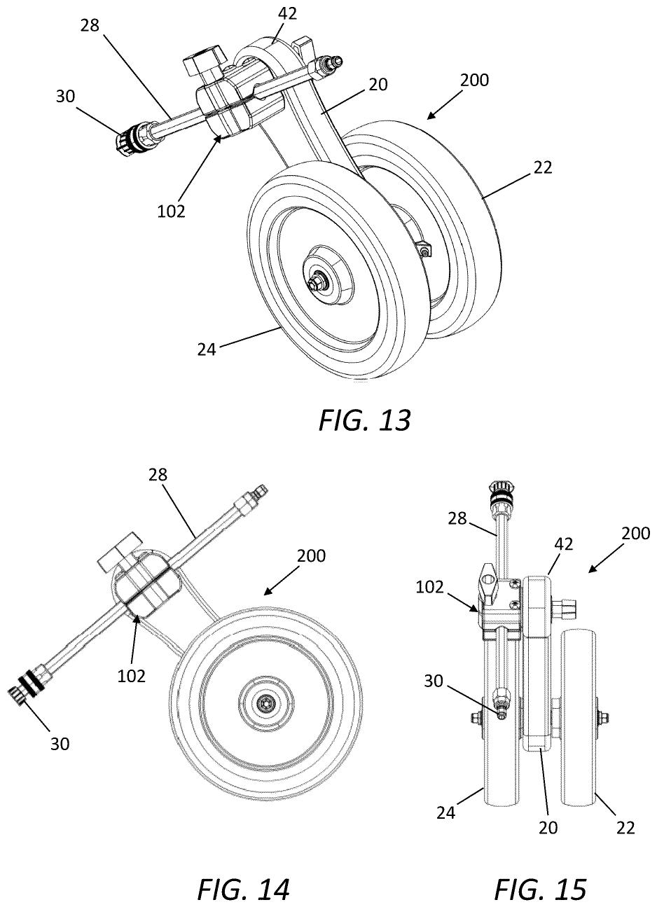

The wand nest 102 can be detached from the bracket 42 by simply unscrewing the torquing bolt 112 from the threaded bore 108 and then dismounting the bottom clamp pad 38 from the clutch mount. In this way, the wand nest 102 can be dismounted easily as a single unit from the bracket 42 without necessarily either dismounting the top clamp pad 40 from the bottom clamp pad 38 or removing the wand 12 from the wand nest 102. The wand nest 102 can thereafter be easily remounted to the bracket 42 or mounted to another wand carriage having a similar tapered recess clutch mount. For example, FIGS. 13-15 show the wand carriage 200 as also configured to carry the wand nest 102. Like the previous wand carriages 10 and 100, the wand carriage 200 includes a frame 20 with wheels 22 and 24 and a mounting bracket 42 with a clutch mount defined by a tapered recessed 120 as described previously. In this embodiment, the frame 20 has a narrower body defined by a single leg (rather than the inverted V-shaped frame) to enable the carriage 200 to be operated along narrower areas and along edges of a surface, such as along a wall or deck rail. In this embodiment, the wand nest 102 is disposed in the plane of one of the wheels 22 and 24, in this case, directly over the wheel 24, so that the nozzle 30 is able to propel a stream along the edge of the path of travel of the wheel 24 rather than in the middle of the wand carriage 200. Thus, the wand nest 102 can be quickly and easily dismounted from one wand carriage 100 or 200 and mounted to the other wand carriage 100 or 200 for use in different circumstances. For example, the wand carriage 100 may be more convenient for using the power washer in larger areas, whereas the wand carriage 200 may be more convenient for using to power wash edge areas and narrower areas.

In some embodiments, the wand carriage 100, the wand carriage 200, and the wand nest 102 may be provided together, for example as a kit, so that a user can quickly and easily mount the wand 12 of a pressure washer system 14 to either carriage 100 or 200, depending on the surface to be power washed.

As previously noted above, though the foregoing detailed description describes certain aspects of one or more particular embodiments of the invention, alternatives could be adopted by one skilled in the art. For example, the wand carriages and their components could differ in appearance and construction from the embodiments described herein and shown in the drawings, functions of certain components of the wand carriages could be performed by components of different construction but capable of a similar (though not necessarily equivalent) function, and various materials could be used in the fabrication of the wand carriages and/or their components. As such, and again as was previously noted, it should be understood that the invention is not necessarily limited to any particular embodiment described herein or illustrated in the drawings.

1. A wand carriage for supporting a wand of a pressure washer system, the wand carriage comprising:
a frame;
a wheel rotatably coupled to the frame and configured to engage a support surface to support the frame in a spaced relation from the frame;
a wand nest mounted to the frame, the wand nest including an adjustment mechanism for adjusting an angular orientation of the wand nest relative to the frame.

2. The wand carriage of claim 1, wherein the adjustment mechanism comprises a screw that secures the wand nest to the frame.

3. The wand carriage of claim 2, wherein the adjustment mechanism comprises a tapered clutch.

4. The wand carriage of claim 3, wherein tightening the screw tightens the tapered clutch into a fixed pitch orientation and loosening the screw releases the tapered clutch so the pitch orientation of the wand nest can be adjusted.

5. The wand carriage of claim 4, wherein the tapered clutch comprises a tapered boss that fits rotatably into a tapered recess in the frame.

6. The wand carriage of claim 5, wherein the tapered clutch comprises a resilient friction member disposed between and engaging both of the tapered boss and the tapered recess.

7. The wand carriage of claim 6, wherein the resilient friction member comprises a resilient O-ring.

8. The wand carriage of claim 7, wherein the resilient O-ring is disposed in a circumferential groove in one of the tapered boss and the tapered recess.

9. The wand carriage of claim 5, wherein each of the tapered boss and the tapered recess has a tapered circumferential sidewall in the shape of a frustum, and wherein the tapered circumferential sidewall of the tapered boss nests into and against the tapered circumferential sidewall of the tapered recess.

10. The wand carriage of claim 4, wherein the wand nest comprises a first clamp pad that releasably clamps to a second clamp pad, and wherein the tapered boss is fixedly coupled to the second clamp pad.

11. The wand carriage of claim 10, wherein the first clamp pad and the second clamp pad define a receiving cavity therebetween for receiving and clamping a wand tube therein.

12. The wand carriage of claim 11, wherein a first clamp screw loosely attaches the first clamp pad to the second clamp pad to define the receiving cavity, and where a second screw can be tightened or loosened to adjust a clamping force between the first clamp pad and the second clamp pad.

13. A kit for use with a pressure washer system having a wand with a nozzle, the kit comprising:
a first wheeled wand carriage;
a second wheeled wand carriage; and
a wand nest for clamping to the wand;
wherein each wheeled wand carriage comprises a mounting bracket, and the wand nest can be alternatively mounted to the mounting bracket of each of the first wheeled wand carriage and the second wheeled wand carriage; and
wherein a pitch orientation of the wand carriage can be adjusted relative to each of the first wheeled carriage and the second wheeled carriage when mounted thereto, respectively.

14. The kit of claim 13, wherein the wand nest comprises a tapered clutch, and wherein the mounting bracket of each of the first wheeled wand carriage and the second wheeled wand carriage comprises a clutch mount that receives the tapered clutch.

15. The kit of claim 13, wherein the first wheeled carriage comprises a first frame mounted between two wheels, the second wheeled carriage comprises a second frame mounted on at least one wheel, and the first frame is wider in a width direction extending along an axis of the wheels than the second frame.

16. The kit of claim 15, wherein the first wheeled carriage comprises a first bracket portion of the first frame that mounts the wand nest between the wheels in the width direction.

17. The kit of claim 15, wherein the second wheeled carriage comprises a second bracket portion of the second frame that mounts the wand nest aligned with the at least one wheel in the width direction.

18. A pressure washer system comprising the wand carriage of claim 1.

19. A pressure washer system comprising the kit of claim 13.
